(19) United States
(12) Patent Application Publication
(10) Pub. No.: US 2006/0056941 A1
(43) Pub. Date: Mar. 16, 2006

(54) Clip

(75) Inventor: Yukikazu Niiduma, Toyonaka-shi (JP)

Correspondence Address: KANESAKA BERNER AND PARTNERS LLP, SUITE 300, 1700 DIAGONAL RD, ALEXANDRIA, VA, 22314-2848, US

(73) Assignee: NIFCO INC., Yokohama (JP)

(21) Appl. No.: 11/193,333

(22) Filed: Aug. 1, 2005

(30) Foreign Application Priority Data
Sep. 13, 2004 (JP) 2004-265241

(51) Int. Cl. F16B 19/00

(52) U.S. Cl. 411/508

(57) ABSTRACT

A clip is used, for example, to attach a light reflecting plate of a backlight to a frame plate of a liquid crystal cell of a liquid crystal display. The light reflecting plate has a penetrating hole, and the frame plate has a mounting hole. The clip includes a supporting plate, an elevated portion formed on a backside of the supporting plate and having a size closing the mounting hole, and a leg portion protruding from the backside of the elevated portion to enter the penetrating hole and the mounting hole. An engaging portion is provided on the leg portion for engaging the mounting hole when the leg portion is inserted into the mounting hole and the penetrating hole.

### BACKGROUND OF THE INVENTION AND RELATED ART STATEMENT

The present invention relates to a clip for attaching a backlight reflecting plate of a liquid crystal display to a backside of a liquid crystal cell.

In a liquid crystal display such as a liquid crystal television, in general, backlights K are provided on a backside of a liquid crystal cell L, so that the backlights K transmit light c through the liquid crystal cell L. A reflecting plate R (generally, a white plate-like member) is provided at a rear side of the backlights K. The reflecting plate R is attached to a frame plate F (generally, a steel plate) by a clip C′ (see FIG. 8).

The clip C′ includes leg portions 110 projecting from a backside of a supporting plate 100. The leg portions 110 include engaging portions 111 for engaging mounting holes Fa formed in the frame plate F. Penetrating holes Ra are formed in the reflecting plate R provided on a front side of the frame plate F. The leg portions 110 are inserted into the mounting holes Fa and the penetrating holes Ra from a side of the liquid crystal cell L. When the leg portions 110 are elastically deformed and completely fitted, the engaging portions 111 elastically engage the mounting holes Fa.

In the conventional clip C′ shown in FIG. 8, base portions 112 of the leg portions 110 having a thickness smaller than a diameter of the mounting holes Fa are integrally formed on a back surface of the supporting plate 100. As a result, the light c of the backlights K transmitting through the supporting plate 100 leaks backward through the penetrating holes Ra and the mounting holes Fa (FIG. 8). When the light c leaks as described above, an unnecessary light spot is generated on a surface of a backward wall H through air holes Pa formed in a case-member back P of the liquid crystal display. Therefore, conventionally, an additional light-shielding sheet S such as a non-woven fabric and the like is disposed on the back surface of the frame plate F to prevent leakage of the light through the mounting holes Fa (FIG. 9).

An object of the present invention is to provide a clip with a structure wherein light from a backlight does not leak through a mounting hole of the clip provided on a frame plate for attaching a reflecting plate of the backlight.

Further objects and advantages of the invention will be apparent from the following description of the invention.

### SUMMARY OF THE INVENTION

In order to solve the above-mentioned problems, according to the present invention, a clip includes a leg portion projecting from a backside of a supporting plate. The leg portion includes an engaging portion for engaging a mounting hole. The mounting hole has a frame plate shape and is formed in a backside surface of a liquid crystal cell constituting a liquid crystal display. A penetrating hole is formed in a light reflecting plate of a backlight provided on a front side of the frame plate. The leg portion is inserted into the mounting hole and the penetrating hole from a side of the liquid crystal cell, and then elastically deformed. When the leg portion is elastically deformed and completely fitted, the engaging portion engages the mounting hole. In the clip, a base portion of the leg portion is integrated with an elevated portion with a size for blocking the mounting hole formed in the backside of the supporting plate.

With the structure described above, the leg portion is inserted into the penetrating hole and the mounting hole from the side of the liquid crystal cell in a state wherein the penetrating hole and the mounting hole communicate with each other. As a result, the reflecting plate and the frame plate are sandwiched between the supporting plate and the engaging portion, and the reflecting plate can be attached to the frame plate via the clip with one easy operation. The leg portion has a size of being inserted into the mounting hole, and the elevated portion has a size for blocking the mounting hole. Accordingly, the clip can prevent light of the backlight transmitting through the supporting plate from leaking backward through the penetrating hole and the mounting hole.

The elevated portion may have a thickness or height so that a part of the elevated portion can be inserted into the mounting hole of the frame plate through the penetrating hole of the reflecting plate.

In this case, the elevated portion is made as thick as possible, so that the light transmitting through the supporting plate can be prevented from transmitting beyond the elevated portion.

A slot-like portion may be formed in the elevated portion of the supporting plate located in front of the elevated portion. At the same time, a textured surface may be formed on an inner surface of the slot-like portion.

In this case, the light transmitting from a front side and entering the slot-like portion can be scattered by the inner face and diffused. Accordingly, the light of the backlight can be prevented from transmitting beyond the elevated portion.

According to the present invention, the clip can prevent the light of the backlight from leaking backward through the mounting hole of the clip provided in the frame plate for attaching the reflecting plate of the backlight of the liquid crystal cell.

### BRIEF DESCRIPTION OF THE DRAWINGS

FIG. 1 is a front view of a clip C;

FIG. 2 is a plan view thereof;

FIG. 3 is a left side view thereof;

FIG. 4 is a bottom plan view thereof;

FIG. 5 is a cross sectional view taken along line 5-5 in FIG. 1;

FIG. 6 is an enlarged front view of a portion 6 in FIG. 1;

FIG. 7 is a structural view showing a use state;

FIG. 8 is a structural view showing a conventional example in a use state; and

FIG. 9 is a structural view showing the conventional example in a use state.

### DETAILED DESCRIPTION OF PREFERRED EMBODIMENTS

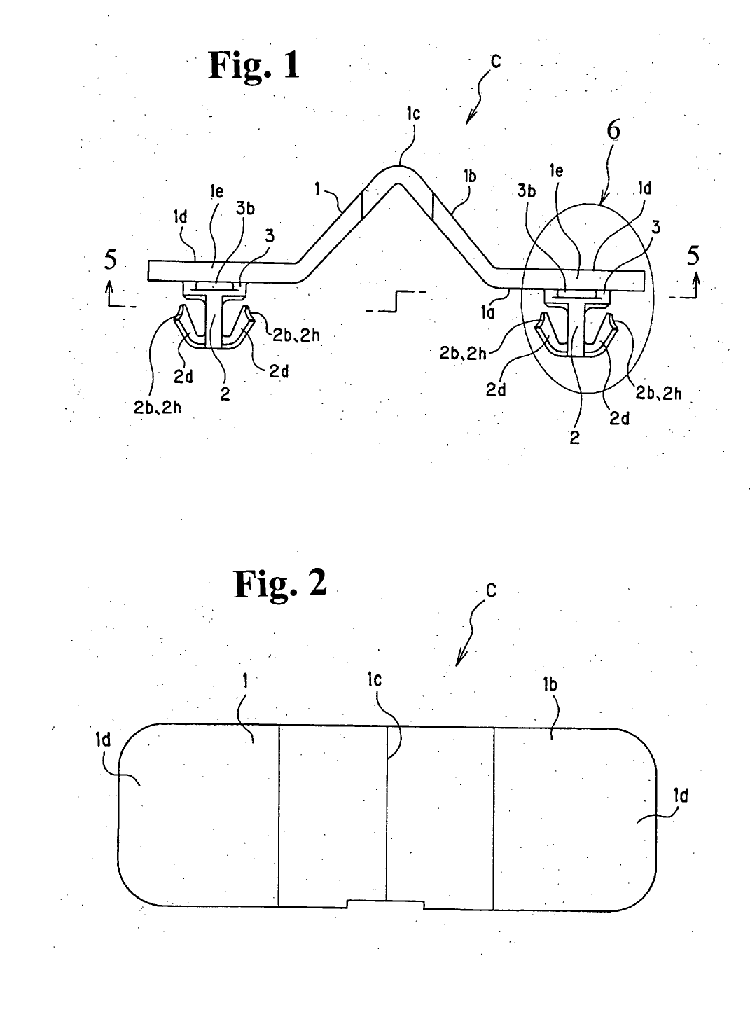

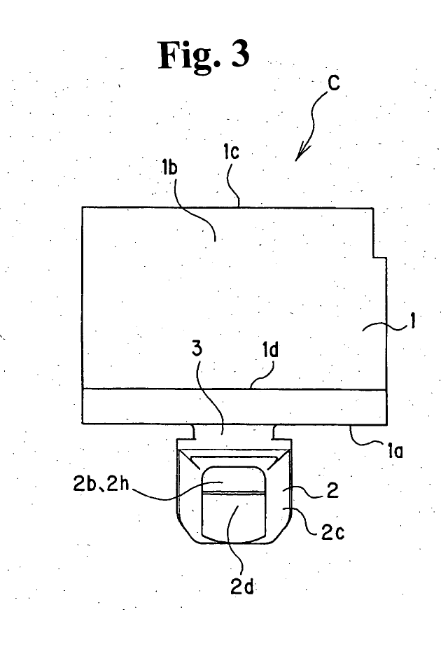

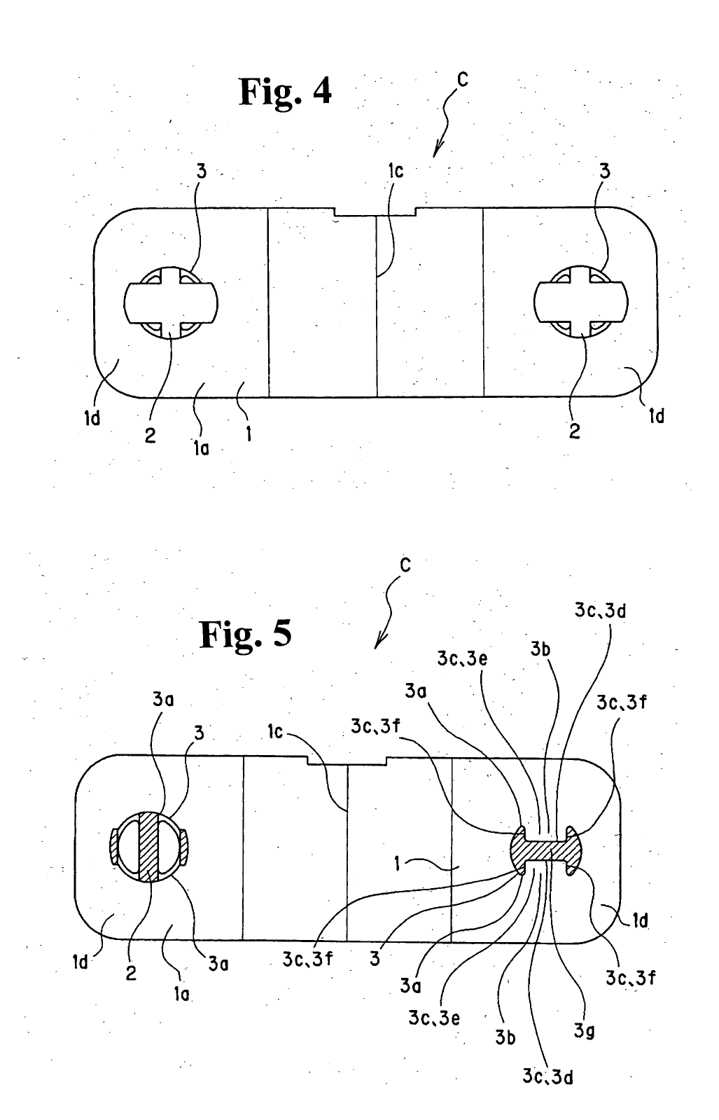

Hereinafter, embodiments of the present invention will be explained with reference to FIGS. 1 to 7.

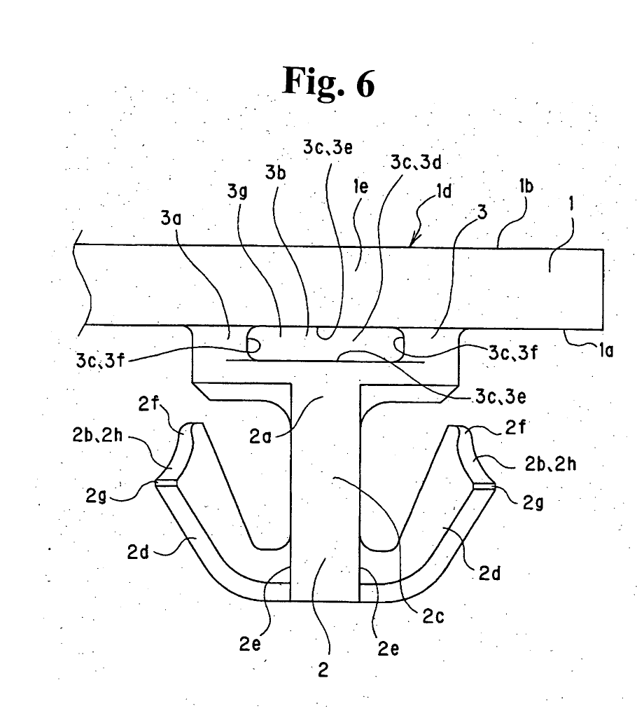

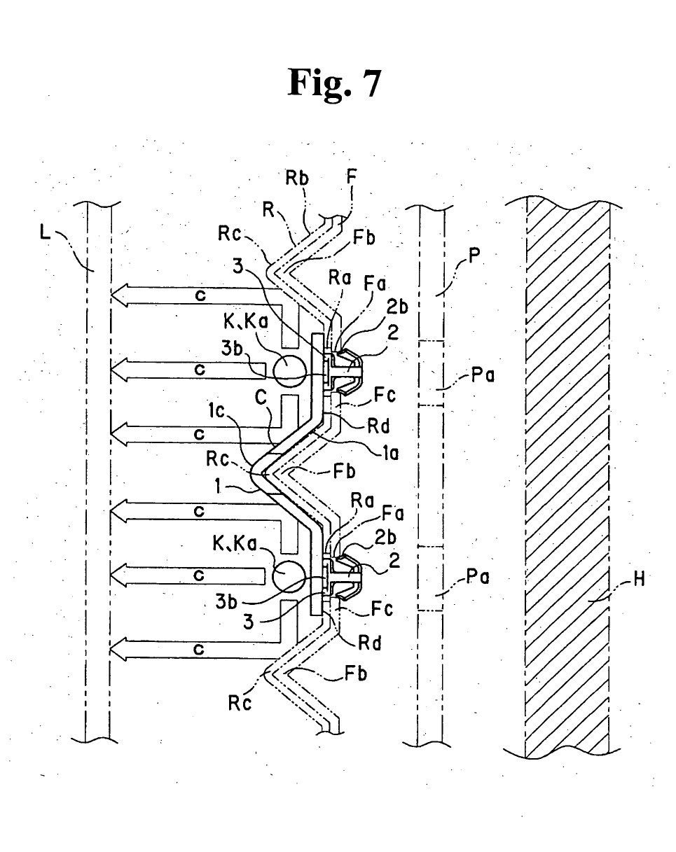

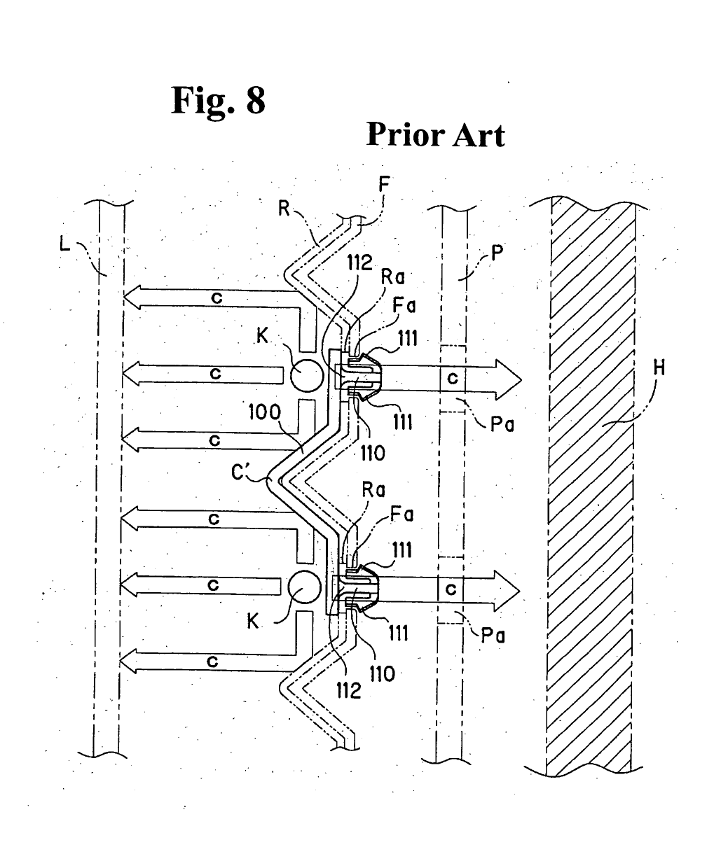

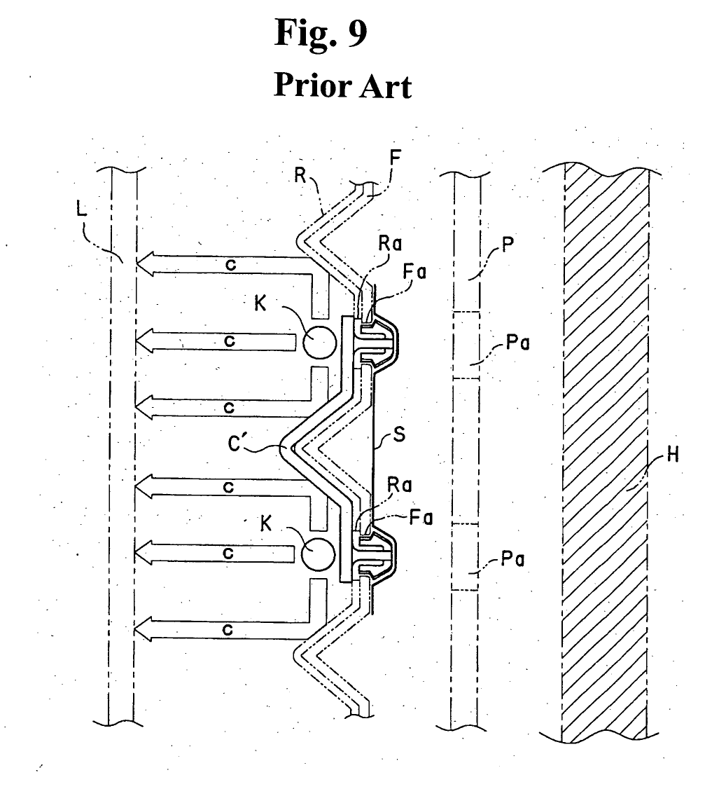

Incidentally, FIGS. 1 to 5 show a clip C according to an embodiment, respectively. FIG. 6 shows the clip C, especially, an enlarged leg portion 2. FIG. 7 shows the clip C in a use state.

The clip C of the embodiment is used for attaching a reflecting plate R of backlights K in a liquid crystal display to a backside of a liquid crystal cell L.

The clip C includes a supporting plate 1, and leg portions 2 projecting from a backside 1a of the supporting plate 1. The leg portion 2 includes engaging portions 2b for engaging mounting holes Fa. The mounting holes Fa are formed in a frame plate F provided on a backside of the liquid crystal cell L constituting the liquid crystal display. Penetrating holes Ra are formed in the reflecting plate R of light c of the backlights K provided on a front side of the frame plate F. The leg portions 2 are inserted into the mounting holes Fa and the penetrating holes Ra from a side of the liquid crystal cell L, and then elastically deformed. After the leg portions 2 are elastically deformed and completely fitted, the leg portions 2 elastically return the engaging portions 2b to engage the mounting holes Fa. The reflecting plate R is generally white, and the clip C is also white.

Specifically, in the clip C, the leg portions 2 are inserted into the mounting holes Fa and the penetrating holes Ra to a position wherein the backside 1a of the supporting plate 1 contacts a surface Rb of the reflecting plate R in a state wherein the mounting holes Fa and the penetrating holes Ra communicate with each other. Accordingly, the reflecting plate R and the frame plate F are sandwiched between the supporting plate 1 and the engaging portions 2b of the leg portions 2, and the reflecting plate R can be attached to the frame plate F via the clip C.

In the embodiment shown in the figures, the supporting plate 1 is a long and thin plate, and curved at a roughly middle position thereof in a length direction in such a way of having a mountain-like portion 1c projecting forward from a surface side. Both end portions 1d sandwiching the mountain-like portion 1c has a front surface 1b and a back surface 1a at the same level. The leg portions 2 are provided to project from the backside surface 1a of the both end portions 1d of the supporting plate 1, respectively.

The leg portion 2 includes a leg main body 2c formed of a plate with a plate surface along a width direction of the supporting plate 1, and elastic pieces 2d provided on both sides of the leg main body 2c. A pair of elastic pieces 2d has end pieces 2e integrated with tip of the leg main body 2c, and projects from the tips toward a base side of the leg main body 2c. The elastic pieces 2d are inclined in such a way that both inner and outer surfaces of the elastic pieces 2d separate from the leg main body 2c as the elastic pieces 2d move toward the other end pieces 2f. Engaging faces 2h as outer face portions of the elastic pieces 2d are formed at tips of top portions 2g of the other end pieces 2f. The engaging faces 2h face the backside surface 1a of the supporting plate 1.

A sum of thicknesses of the reflecting plate R and the frame plate F is roughly equal to a pitch between the backside surface 1a of the supporting plate 1 and the engaging faces 2h of the elastic pieces 2d. A pitch between the top portions 2g of the other end pieces 2f of a pair of elastic pieces 2d is roughly equal to a diameter of the penetrating holes Ra, and slightly larger than a diameter of the mounting holes Fa.

In the embodiment shown in the figures, the reflecting plate R includes a number of mountain-like portions Rc continuing from side to side and left spaces above and below; and flat portions Rd provided between the adjacent mountain-like portions Rc along a vertical direction. The flat portions Rd include the penetrating holes Ra. In addition, fluorescent tubes Ka composing the backlights K are interposed between the adjacent mountain-like portion 1c. The frame plate F includes: mountain-like portions Fb following a shape of the reflecting plate R; and flat portions Fc. The flat portions Fc include the mounting holes Fa.

In the embodiment shown in the figures, the backside 1a of the mountain-like portion 1c of the supporting plate 1 of the clip C is pressed against surfaces Rb of the mountain-like portions Rc of the reflecting plate R. Also, the backside 1a of one end portion 1d of the supporting plate 1 is pressed against the surface Rb of one flat portion Rd sandwiching the mountain-like portions Rc of the reflecting plate R. The leg portions 2 are inserted into the penetrating holes Ra and the mounting holes Fa communicating with other and fitted therein until the backside 1a of the other end portion 1d of the supporting plate 1 is pressed against the surface Rb of the other flat portion Rd sandwiching the mountain-like portions Rc of the reflecting plate R. Accordingly, the top portions 2g contact edges and inner walls of the mounting holes Fa. The top portions 2g of the pair of elastic pieces 2d are bent inwardly once, and elastically project forward from edges of inserted tips of the mounting holes Fa. As a result, the engaging faces 2h engage the edges of the inserted tips. Accordingly, the reflecting plate R is attached to the frame plate F via the clip C.

In the embodiment, the base portion 2a of the leg portion 2 is integrated with the elevated portion 3 with a size of roughly blocking the mounting hole Fa formed on the backside 1a of the supporting plate 1. The leg portion 2 are provided in the supporting plate 1.

In the embodiment shown in the figures, each elevated portion 3 is formed in a short cylindrical shape with a diameter roughly equal to a width size of each leg main body 2c. A diameter of the elevated portion 3 is smaller than a diameter of the penetrating holes Ra and roughly equal to a diameter of the mounting hole Fa.

In addition, each elevated portion 3 has a thickness wherein a part of the elevated portion 3 can be inserted into each mounting hole Fa of the frame plate F through each penetrating hole Ra of the reflecting plate R. Specifically, in an attached state of the reflecting plate R wherein the clip C engages the frame plate F as mentioned above, a projecting portion of each elevated portion 3 from the backside 1a of the supporting plate 1 has a size such that an elevated edge of each elevated portion 3 can be inserted into each mounting hole Fa of the frame plate F.

According to the clip C of the embodiment, the leg portions 2 are inserted into the penetrating holes Ra and the mounting holes Fa from the side of the liquid crystal cell L in a state wherein the penetrating holes Ra and the mounting holes Fa communicate with each other. As a result, the reflecting plate R and the frame plate F are sandwiched between the supporting plate 1 and the engaging portions 2b, and the reflecting plate R can be attached to the frame plate F via the clip C with one easy operation. The leg portions 2 have a thickness that can be inserted into the mounting holes Fa. The elevated portion 3 have a size of roughly closing the mounting hole Fa. Accordingly, the clip C itself can prevent the light c of the backlights K transmitting through the supporting plate 1 from leaking backward through the penetrating hole Ra and the mounting hole Fa. Accordingly, the light does not illuminate a surface of a wall H located on a rear side of air holes Pa formed in a case-member back P of the liquid crystal display.

The elevated portion 3 has the thickness such that the part of the elevated portion 3 can be inserted into the mounting hole Fa of the frame plate F through the penetrating hole Ra of the reflecting plate R. Accordingly, the elevated portion 3 can be thick without hindering the function of the clip C, so that the light c passing through the supporting plate 1 can be prevented from transmitting beyond the elevated portion 3.

In the embodiment, slot-like portions 3b are formed in the elevated portions 3. Textured surfaces (not shown) may be formed on inner surfaces 3c of the slot-like portions 3b.

In the embodiment shown in the figures, the slot-like portion 3b is open in side portions 3a of the elevated portion 3 and continues into the elevated portion 3. The slot-like portion 3b is formed in the side portions 3a of the elevated portion 3 facing edges of the supporting plate 1 along the length direction. In addition, the core portion 3g is disposed between the back-hole walls 3d of the slot-like portions 3b formed from one side portion 3a and the other side portion 3a of the elevated portion 3. The textured surfaces are formed on the back-hole walls 3d of the slot-like portions 3b, a pair of side walls 3e perpendicular to a projecting direction of the elevated portions 3, and a pair of side walls 3f along the projecting direction of the elevated portions 3, respectively. In the embodiment, the clip C is a plastic molded part. The textured surfaces can be formed in the inner surfaces 3c of the slot-like portions 3b by creating a textured surface on a mold surface for forming and shaping the slot-like portions 3b by etching.

In the embodiment, the light c of the backlights K transmitting from a front side and entering the slot-like portions 3b can be reflected by the inner surfaces 3c of the slot-like portions 3b and diffused. Accordingly, the light c of the backlights K can be prevented from transmitting beyond the elevated portion 3.

The slot-like portions 3b may be formed within a thickness 1e of the supporting plate 1 located in front of the elevated portions 3.

In this case, the light c of the backlights K transmitting from the front side and entering into the slot-like portions 3b can be scattered by the inner surfaces 3c of the slot-like portions 3b and diffused. Accordingly, the light c of the backlights K can be prevented from transmitting beyond the elevated portions 3.

The disclosure of Japanese Patent Application No. 2004-265241, filed on Sep. 13, 2004, is incorporated in the application.

While the invention has been explained with reference to the specific embodiments of the invention, the explanation is illustrative and the invention is limited only by the appended claims.

What is claimed is:

1. A clip for attaching a plate with a penetrating hole to a frame plate with a mounting hole, comprising:
a supporting plate,
an elevated portion formed on a backside of the supporting plate and having a size to substantially close the mounting hole, and
a leg portion extending outwardly from the elevated portion, and having an engaging portion with elasticity, said engaging portion, when the leg portion is inserted into the mounting hole and the penetrating hole, being bent to pass through the mounting and penetrating holes and returning to an original shape to engaging therewith.

2. A clip according to claim 1, wherein said leg portion has a base portion integrated with the elevated portion.

3. A clip according to claim 1, wherein said elevated portion has a height such that a part of the elevated portion is inserted into the mounting hole through the penetrating hole.

4. A clip according to claim 1, wherein said elevated portion includes a slot-like portion having a textured inner surface.

5. A clip according to claim 1, wherein said elevated portion has a cylindrical shape with two dents formed symmetrically at a side portion thereof.

6. A clip according to claim 5, wherein said leg portion includes a leg main body having a rectangular shape, and two elastic pieces formed on two sides of the leg main body substantially parallel thereto.

7. A clip according to claim 6, wherein said two elastic pieces have a length and width less than those of the leg main body.
